(19) United States
(12) Patent Application Publication
(10) Pub. No.: US 2004/0061931 A1
(43) Pub. Date: Apr. 1, 2004

(54) Night vision arrangement

(76) Inventors: Jan-Erik Kallhammer, Goteborg (SE); Dick Eriksson, Alingsas (SE); Lars Karlsson, Taby (SE); Staffan Straat, Enebyberg (SE)

Correspondence Address: YOUNG & THOMPSON, 745 SOUTH 23RD STREET 2ND FLOOR, ARLINGTON, VA, 22202

(21) Appl. No.: 10/423,009

(22) Filed: Apr. 25, 2003

Related U.S. Application Data
(63) Continuation of application No. PCT/SE01/02253, filed on Oct. 16, 2001.

(30) Foreign Application Priority Data
Oct. 26, 2000 (SE) 0003942-0

(51) Int. Cl. G02B 1/00

(52) U.S. Cl. 359/362

(57) ABSTRACT

In a night vision arrangement for a motor vehicle a camera (1) is provided which captures an image which is subsequently displayed on a display arrangement (3) which may be a head-up display arrangement. The camera (1) has a lens (4) which is aligned with a beam deflector (6) which may be constituted by a mirror (7) which deflects the beam so that is passes along a neck (8) on to a sensor (11). The camera may relatively easily be mounted in position in a motor vehicle.

THE PRESENT INVENTION relates to a night vision arrangement in the form of a device for the enhancement of night vision of a vehicle, such as an automobile.

It has been proposed previously to provide a night vision arrangement in an automobile. U.S. Pat. No. 5,414,439 discloses an arrangement in which a vehicle is equipped with an infra-red sensitive camera which is directed to capture an image of the roadway in front of the vehicle. The camera provides an output in the form of a video signal which is processed by a video processor, and which is then passed to a head-up display. It has been known previously to provide head-up display units in vehicles such as combat aircraft to enable the pilots of the aircraft to view, simultaneously, the scene on the exterior of the aircraft, and also an image projected on to the head-up display. U.S. Pat. No. 5,414,439 utilises a head-up display of this general type to enable the driver of the vehicle to view the road in front of the vehicle and, simultaneously, to see an image derived from the infra-red camera.

In the arrangement of U.S. Pat. No. 5,414,439, the windshield is provided with a semi-transparent mirror which is utilised as a combiner to combine the real image of the road in front of the vehicle as viewed by the driver, and a virtual image of the road ahead.

The infra-red sensitive camera of U.S. Pat. No. 5,414,439 is of conventional design incorporating a lens arrangement which serves to focus an image on a relatively large sensor element which is located in alignment with the optical axis of the lens arrangement. The entire camera is rather bulky and the positioning of the camera is shown, schematically, with the camera being mounted within the engine compartment of the vehicle.

The present invention seeks to provide an improved night vision arrangement.

According to this invention there is provided a night vision arrangement for a vehicle, the night vision arrangement incorporating a camera, the camera comprising a lens, and an infra-red sensor to capture an image received through the lens, therebeing a display unit to display the captured image to a driver of the vehicle, characterised in that the lens defines an optical axis, and within the camera a beam deflector is provided in alignment with the optical axis adapted to deflect the beam received through the lens and to direct the deflected beam on to the said sensing means.

Preferably the beam deflector is adapted to deflect the beam through approximately 90°. The angle of deflection of the beam deflected by the beam deflector does depend upon the detailed design of the camera, and the intended location of the camera. It is intended that the camera should be mounted in position with only the lens exposed.

Conveniently the beam deflector comprises a mirror. Alternatively the beam deflector may comprise a prism or some other optical unit which deflects the beam.

Preferably the lens is provided with a domed exterior surface. This may help ensure that the exterior of the dome remains clean.

Conveniently the lens is provided with a hard coated exterior surface which is coated with micro diamond. This may ensure that the lens proves to be durable, especially if the arrangement is used in a harsh environment where there is grit or dust in the air.

Advantageously a part of the camera containing the sensor is mounted within the envelope of the vehicle, with the lens being positioned or positionable on the exterior of the vehicle. If the main part of the camera, which contains the sensor, is mounted within the envelope of the vehicle, the aerodynamic property of the vehicle will not be influenced substantially by the camera arrangement. Also, the mounting of the camera in position, during the assembly of the vehicle, may be facilitated.

Conveniently means are provided to heat the lens of the camera. This may minimise any problems that might otherwise arise due to condensation.

Preferably means are provided for rinsing the lens with water. The means for rinsing the lens with water may comprise a windscreen washer arrangement. The rinsing of the lens with water may assist in keeping the lens clean.

Conveniently means are provided to wipe the lens. The means to wipe the lens may comprise a wiper blade, a mechanism being provided to effect a relative movement between the lens and the wiper blade.

Advantageously means are provided to protect the lens from the environment. Thus the lens may be protected from the environment at times when the night vision arrangement is not in use.

In one embodiment the means provided to protect the lens from the environment comprise a cover movable to a position in which the lens is covered.

In another embodiment the means to protect the lens comprise means to move the camera and the lens so that the lens is in a retracted and protected position.

In one preferred embodiment the camera is mounted between the rear of the hood of a motor vehicle and the windshield.

Preferably the camera is mounted in position for pivotal movement about a horizontal axis parallel with the axis of the vehicle between an operative position and a retracted position, a wiper being provided to wipe the lens as the camera moves.

In an alternative embodiment the camera is incorporated into a mirror housing.

In another modified embodiment the camera is mounted in a fender or bumper.

Conveniently the camera is mounted to be moved vertically between an operative position and a retracted position.

Alternatively the camera is provided with a cover movable between a retracted position in which the lens is exposed, and a closed position in which the lens is covered.

In another embodiment of the invention the camera is adapted to be mounted on the roof of a vehicle.

Conveniently the cover is incorporated in a roof mounted aerial.

Alteratively the camera is incorporated in a roof rail.

According to another embodiment of this invention there is provided a device for the enhancement of night vision in a vehicle like an automobile including an infra-red camera, comprising a lens and an infra-red sensing means, mounted on the vehicle to view the roadway in front of the vehicle, generating a video signal representing the thermal image of the roadway, a processing unit and a display unit to make the image visible to the vehicle operator, characterised in that the lens is mounted on an elongated neck portion of the device, comprising optical means for conveying the infra-red radiation to the infra-red sensing means.

In order that the invention may be more readily understood, and so that further features thereof may be appreciated, the invention will now be described by way of example, with reference to the accompanying drawings in which:

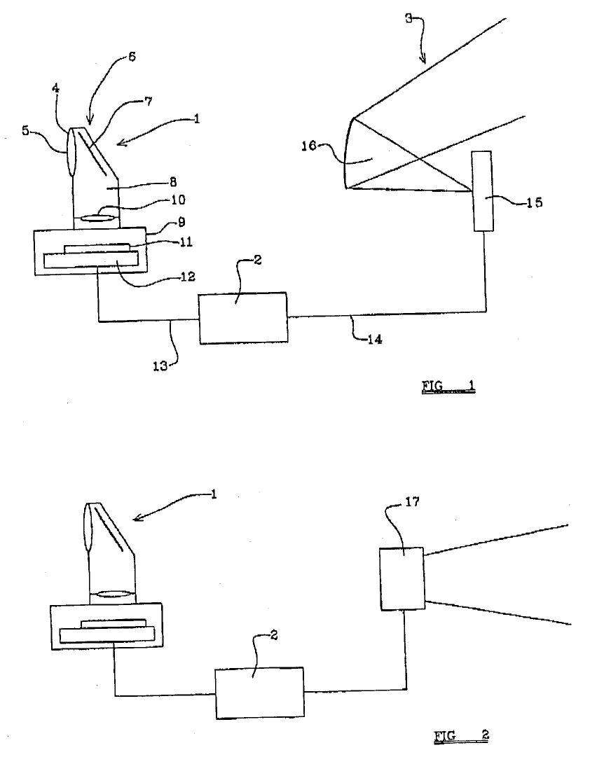

FIG. 1 is a schematic illustration of a night vision arrangement for a motor vehicle in accordance with the invention,

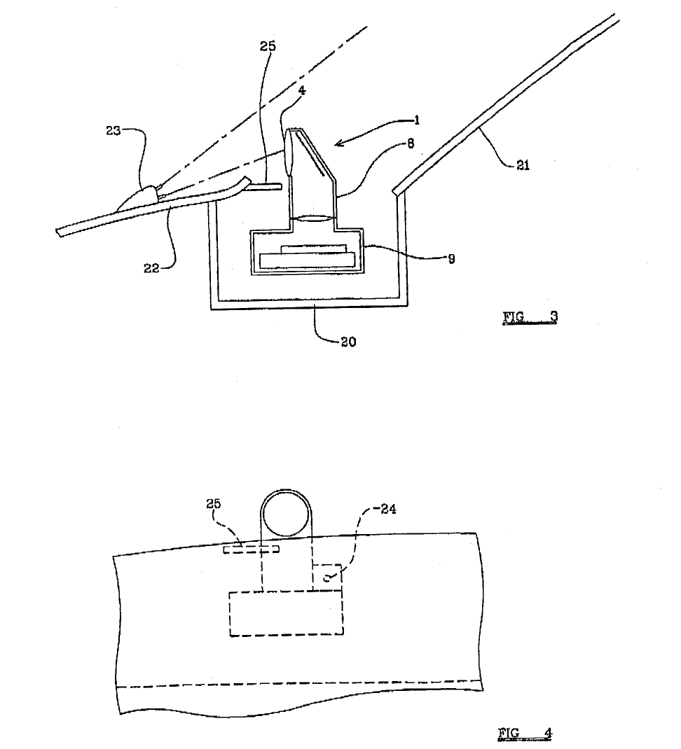

FIG. 2 is a view similar to that of FIG. 1 illustrating a modified embodiment of the invention,

FIG. 3 is a diagrammatic side view illustrating a camera of one embodiment of the invention mounted in position on a motor vehicle,

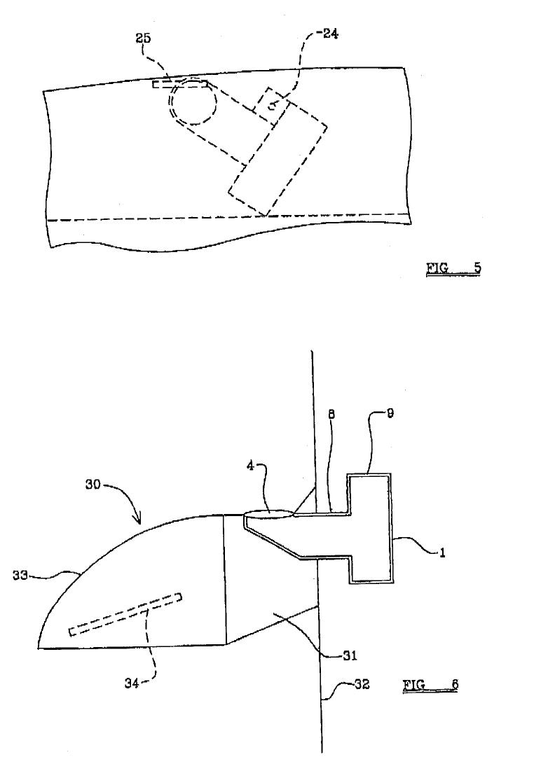

FIG. 4 is a front view of the camera of FIG. 3 in the operative position,

FIG. 5 is a front view corresponding to FIG. 4 illustrating the camera of FIG. 3 in a non-operative position,

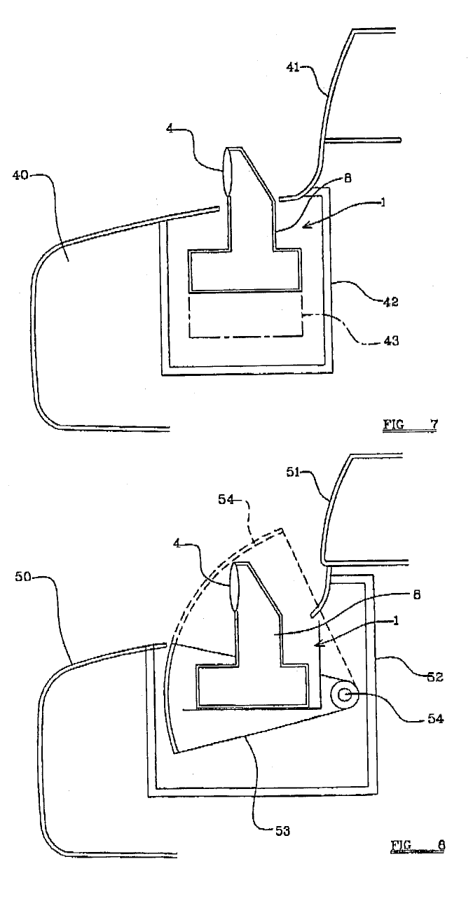

FIG. 6 is diagrammatic view illustrating a camera of another embodiment of the invention,

FIG. 7 is a diagrammatic view illustrating the camera of yet another embodiment of the invention,

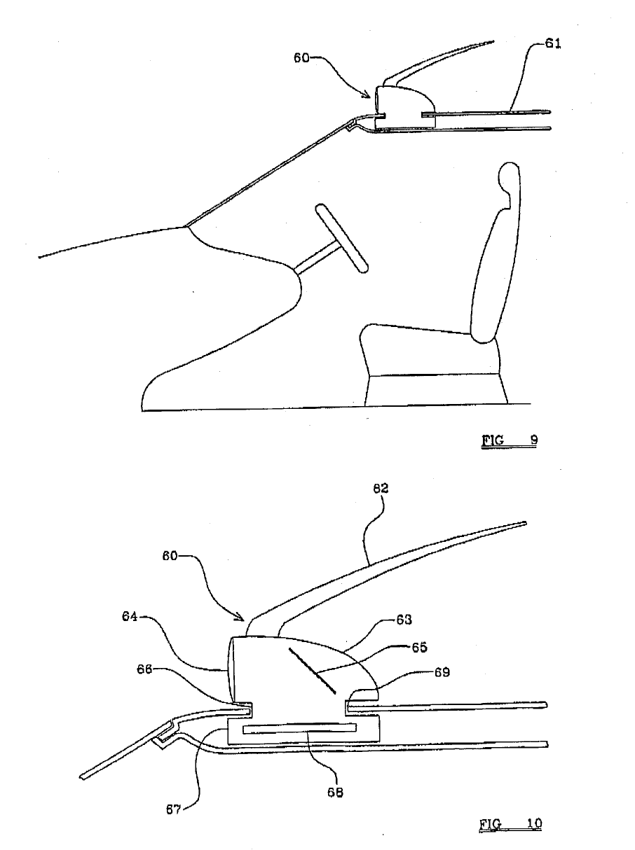

FIG. 8 is a diagrammatic side view illustrating the camera of a further embodiment of the invention,

FIG. 9 is a diagrammatic side view of part of a motor vehicle provided with a camera forming part of the embodiment of the invention,

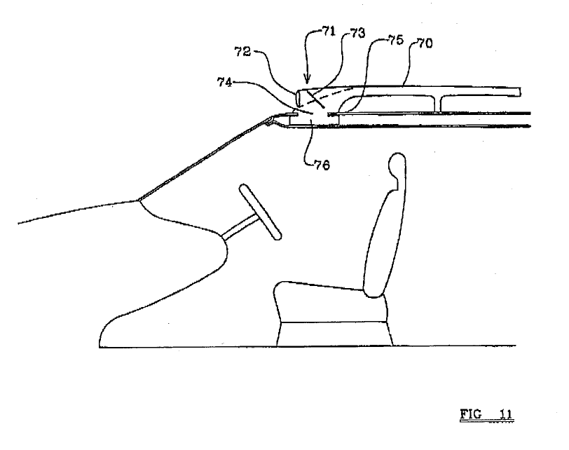

FIG. 10 is an enlarged view of part of FIG. 9, and

FIG. 11 is a side view of part of a vehicle provided with a camera forming part of yet another embodiment of an invention.

Referring initially to FIG. 1 of the accompanying drawings, a night vision arrangement for a vehicle such as motor car comprises a camera arrangement 1 to capture an image, a signal processing unit 2 and a display arrangement 3 adapted to display an image.

The camera arrangement 1 comprises a lens 4 through which infra-red light, forming an image, is to pass into the interior of the camera. The lens 4 is provided with a generally dome-shaped front face 5, that front face being provided with a hard coating formed preferably of micro-size diamond. The lens is dome-shaped to facilitate the removal of water and dirt from the lens by wind drag as the vehicle moves. This is in contrast with many prior lenses which had substantially flat front faces.

The lens 4 defines an optical axis, and, when the camera unit 1 is positioned on a motor vehicle, the optical axis in front of the lens is directed towards the roadway in front of the vehicle, so that the camera can capture an image of the roadway in front of the vehicle.

Behind the lens 4, in alignment with the optical axis, a beam deflector 6 which, in the illustrated embodiment of the invention, is constituted by a mirror 7 which is inclined at substantially 45° to the optical axis of the lens. Thus the beam deflector 6 serves to deflect the beam passing through the lens 4 by approximately 90°.

The beam deflector 6 is connected, by means of an elongate hollow neck 8, to a main housing 9 of the camera 1. Contained within the elongate neck 8 is a focusing lens 10, which serves to focus light from the beam deflector 6 on to a sensor 11 present within the housing 9. The sensor 11 is an infra-red sensor, and may comprise a microbolometer. The sensor may be a charge-coupled device. The sensor is shown mounted on an electronic unit 12 which receives the signals from the sensor and which provides an output on the output lead 13.

It is to be understood, therefore, that the infra-red sensitive camera 2 is provided with a housing 9 which contains an infra-red sensor 11 which is adapted to capture an image, and the housing 9 is connected by means of a hollow neck 8 to a beam deflector 6 which is located adjacent the lens 4.

The output 13 from the camera 1 passes through an image processor unit 2 which provides a signal on a lead 14 which passes to an image generator 15. The image generator 15 may be a cathode ray tube device, or some other equivalent arrangement. The image generator 15 is positioned at an appropriate location generally in front of a combiner 16, which may be mounted on the windshield of a motor vehicle, and which may be a semi-transparent aspheric mirror.

In use of the arrangement, as shown in FIG. 1, the camera 1 will be mounted in a motor vehicle so that the optical axis of the lens 4 is directed generally along the roadway in front of the motor vehicle, enabling the camera 1 to generate an infra-red image of the roadway in front of the vehicle. That image is presented on the image generator 15. The driver of the vehicle may thus simultaneously view, in the combiner 16, the real image of the roadway outside the vehicle, and a virtual image of the roadway, as presented on the image generator 15.

FIG. 2 illustrates a second embodiment of the invention in which the camera 1 and signal processor 2 are exactly as described above with reference to FIG. 1. These components will not be re-described. In this embodiment the output 14 of the signal processing unit 2 is connected directly to a monitor 17, which may be in the form of a cathode ray tube or the like. The monitor 17 is located at a position where it can be viewed by the driver of a motor vehicle.

Referring now to FIGS. 3 to 5, a camera 1, as described above, is illustrated mounted in position on a motor vehicle.

Referring initially to FIG. 3, the camera 1 is mounted in position with the main housing 9 being located within a recess 20 that is formed between the lower edge of the windscreen 21, and the upper edge of the hood or bonnet 22. The recess 20 may also contain past of the windscreen wiper mechanism.

The camera 1 is located in position so that the main housing 9 is located within the recess, with the neck 8 extending vertically upwardly, so that the lens 4 is located above the upper edge of the bonnet 22, thus ensuring that the lens 4 has an adequate “view” of the road in front of the vehicle. The main housing 9 is thus located within the main envelope defined by the vehicle, with only that part of the neck 8 carrying the lens 4 projecting beyond the envelope.

Mounted on the bonnet 22 is a windscreen washer nozzle 23. The windscreen washer nozzle 23 is located so that when the windscreen washer is actuated, water from the nozzle 23 will impinge upon the lens 4, thus facilitating in cleaning the lens 4.

The camera 1 of the embodiment shown in FIGS. 3 to 5, is mounted in position for pivotal movement about a substantially horizontal pivot axis 24, the pivot axis being aligned with the axis of the vehicle. The entire camera may thus pivot from a first operative position, as shown in FIGS. 3 and 4, in which the lens 4 is located above the rear edge of the bonnet 22, to a retracted position, as shown in FIG. 5, in which the lens is positioned beneath the rear edge of the hood or bonnet 2. The lens, in this retracted position, is somewhat protected from the environment which may contain rain or dust.

In the illustrated embodiment, a wiper blade 25 is mounted in position adjacent the rear edge of the hood or bonnet 22 which is located so that, as the camera 1 moves from the operative position of FIG. 4 to the retracted position of FIG. 5, the wiper 25 wipes the lens 4. Thus the lens 4 is kept in a clean condition, not only by virtue of its domed and coated form, but also by the action of the wiper 25.

It is to be appreciated that in the embodiment of FIGS. 3 to 5, the main housing 9 of the camera is, at all times, within the envelope of the vehicle, with the lens 4 being movable to the operative position where it extends beyond the envelope of the vehicle. The optical axis of the lens 4, when the camera is in the operative position, is very close to the actual line of sight of the driver of the vehicle, if the camera is positioned immediately in front of the driver. This serves to minimise any parallax error which might otherwise arise.

The camera of the embodiment of FIGS. 3 to 5 may be driven about the pivot axis 24 by means of an appropriate electric or hydraulic motor. The motor may be controlled so that the camera is only moved to the operative position when the night vision arrangement is actuated, although the driver may have a control which can be actuated to cause the camera to move from the operative position to the retracted position, and back again, so that the driver may effect a cleaning of the lens of the camera.

FIG. 6 illustrates another embodiment of the invention in which a camera 1 as described above is mounted in a motor vehicle, with the camera being mounted in position to form part of a wing mirror unit 30. The wing mirror unit 30 has a base portion 31 connected to part 32 of the door of a vehicle, and has an extension portion 33 which contains the actual mirror 34. In this embodiment the camera 1 is mounted in position with the main housing 9 being located within the door, and with the neck 8 extending horizontally into the base portion 31 of the wing mirror unit 30. The lens 4 is positioned in an appropriate aperture formed in the forward facing part of the base portion 31 of the wing mirror or unit 30. The camera may easily be mounted in this position as the motor vehicle is fabricated.

Referring now to FIG. 7 of the accompanying drawings, a camera 1 of the type described above is shown mounted in position within the bumper or fender 40 of the motor vehicle. The camera 1 is shown in position beneath a headlight 41. The camera is mounted in position within a recess 42 formed in the bumper or fender with the housing 9 within the envelope of the vehicle. The camera is located in position with the neck 8 extending vertically upwardly so that the lens 4 is positioned immediately above the top surface of the bumper or fender 40. Preferably the camera is positioned immediately in front of the driver in order to minimise any parallax problems. In the illustrated embodiment, the camera may move vertically from an upper or elevated position, as shown in solid line, to a lower or retracted position as shown in dotted lines 43. When the camera is in the lower position the lens is retracted into the recess 42 formed in the bumper or fender 40, thus protecting the lens from the environment.

FIG. 8 illustrates a further embodiment in which a camera 1 of the type described above is mounted in position within a bumper or fender 50. Again, the camera 1 is located adjacent a headlight 51. In this embodiment of the invention, the bumper or fender 50 defines a recess 52, and the camera 1 is mounted at a fixed position within the recess 52, with the housing 9 within the envelope of the vehicle. The neck 8 of the camera extends upwardly so that the lens 4 is positioned above the upper edge of the bumper or fender. Mounted within the bumper or fender is a pivotally movable cover 53. The cover 53 is adapted to pivot about a pivot axis 54. The cover may move from a retracted position, as shown in solid lines in FIG. 8, in which the lens 4 is exposed has a clear view across the top part of the bumper or fender 50, to a closed position, as shown in dotted lines 54 in FIG. 8, in which the cover 53 extends in front of and above the lens to cover and protect the lens 4.

Reference is now made to FIGS. 9 and 10 of the accompanying drawings in which an aerial unit 60 is shown mounted on the roof 61 of a motor vehicle. The aerial unit 60 incorporates an aerial or antenna 62 mounted on an upper housing 63. The front part of the upper housing 63 is provided with a lens 64, similar to the lens 4 of the camera described above, the lens 64 having an optical axis aligned with a beam deflector 65 contained within the upper housing 63. The upper housing 63 is connected by means of a neck 66 which extends from the lower part of the tipper housing 63, to a lower housing 67. Contained within the lower housing 67 is an image detector 68, corresponding to the image detector 11 described above. The beam deflector 65 deflects the bean entering the camera through the lens 4 by approximately 90° so that the deflected beam impinges on the image detector 68. Thus the upper housing 63 and the lower housing 67 together constitute a camera which is, effectively, of the same operative design as the camera 1 described above. It is to be noted that the camera of the embodiments of FIGS. 9 and 10 is mounted in position with the neck 66 passing through an aperture 69 formed in the roof sheet of the vehicle. Thus the lower housing 67, containing the sensor 68, is mounted within the envelope of the vehicle. The lower housing 67 is larger than the aperture 69, and so the aerial unit 60 cannot easily be removed from the vehicle.

FIG. 11 illustrates a further embodiment of the invention in which a camera is incorporated within a roof rail of the motor vehicle. Referring to FIG. 11, a roof rail 70 of a motor vehicle has, at its forward-most end, a chamber 71, the front part of the chamber being provided with a lens 72. The lens 72 corresponds with the lens 4 as described above. Contained within the chamber 71 in alignment with the optical axis of the lens 4 is a beam deflector constituted, in this embodiment, by an inclined mirror 73. The lower part of the chamber 71 is connected, by means of a relatively narrow neck 74 which passes through an aperture 75 formed in the roof of the vehicle, the neck 74 terminating in an enlarged lower housing 76 which contains an infra-red sensor of the type described above. The beam entering the camera through the lens 72 is focussed onto the infra-red sensor. It is to be appreciated that in this embodiment the housing containing the sensor is within the envelope of the vehicle.

In all of the described embodiments of the invention, a heater may be provided to heat the lens of the camera to minimise or obviate condensation on the lens. The heater may be an electric heater or may be means to direct heated air from the vehicle heating system on to the lens.

In the present Specification “comprise” means “includes or consists of” and “comprising” means “including or consisting of”.

1. A night vision arrangement for a vehicle, the night vision arrangement incorporating a camera, the camera comprising a lens, and an infra-red sensor to capture an image received through the lens, therebeing a display unit to display the captured image to a driver of the vehicle, characterised in that the lens defines an optical axis, and within the camera a beam deflector is provided in alignment with the optical axis adapted to deflect the beam received through the lens and to direct the deflected beam on to the said sensing means.

2. An arrangement according to claim 1 wherein the beam deflector is adapted to deflect the beam through approximately 90°.

3. An arrangement according to claim 1 or claim 2 wherein the beam deflector comprises a mirror.

4. An arrangement according to any one of the preceding claims wherein the lens is provided with a domed exterior surface.

5. An arrangement according to any one of the preceding claims wherein the lens is provided with a hard coated exterior surface which is coated with micro diamond.

6. A device according to any one of the preceding claims wherein a part of the camera containing the sensor is mounted within the envelope of the vehicle, with the lens being positioned or positionable on the exterior of the vehicle.

7. An arrangement according to any one of the preceding claims wherein means are provided to heat the lens of the camera.

8. An arrangement according to any one of the preceding claims wherein means are provided for rinsing the lens with water.

9. An arrangement according to any one of the preceding claims wherein means are provided to wipe the lens.

10. An arrangement according to any one of the preceding claims wherein means are provided to protect the lens from the environment.

11. An arrangement according to claim 10 wherein the means provided to protect the lens from the environment comprise a cover movable to a position in which the lens is covered.

12. An arrangement according to claim 10 wherein the means to protect the lens comprise means to move the camera and the lens so that the lens is in a retracted and protected position.

13. An arrangement according to any one of the preceding claims wherein the camera is mounted between the rear of the hood of a motor vehicle and the windshield.

14. An arrangement according to claim 13 wherein the camera is mounted in position for pivotal movement about a horizontal axis parallel with the axis of the vehicle between an operative position and a retracted position, a wiper being provided to wipe the lens as the camera moves.

15. An arrangement according to any one of claims 1 to 12 wherein the camera is incorporated into a mirror housing.

16. An arrangement according to any one of claims 1 to 12 wherein the camera is mounted in a fender or bumper.

17. An arrangement according to claim 16 wherein the camera is mounted to be moved vertically between an operative position and a retracted position.

18. An arrangement according to claim 16 in which the camera is provided with a cover movable between a retracted position in which the lens is exposed and a closed position in which the lens is covered.

19. An arrangement according to any one of claims 1 to 12 wherein the camera is adapted to be mounted on the roof of a vehicle.

20. An arrangement according to claim 19 wherein the camera is incorporated in a roof mounted aerial.

21. An arrangement according to claim 19 wherein the camera is incorporated in a roof rail.

22. A device for the enhancement of night vision in a vehicle like an automobile including an infra-red camera, comprising a lens and an infra-red sensing means, mounted on the vehicle to view the roadway in front of the vehicle, generating a video signal representing the thermal image of the roadway, a processing unit and a display unit to make the image visible to the vehicle operator, characterised in that the lens is mounted on an elongated neck portion of the device, comprising optical means for conveying the infra-red radiation to the infra-red sensing means.
